(19) United States
(12) Patent Application Publication
(10) Pub. No.: US 2012/0074187 A1
(43) Pub. Date: Mar. 29, 2012

(54) DEPLOYABLE ROOF RACK SYSTEM

(75) Inventor: James G. Gobart, Rochester, MI (US)

(73) Assignee: GM GLOBAL TECHNOLOGY OPERATIONS, INC., Detroit, MI (US)

(21) Appl. No.: 12/890,790

(22) Filed: Sep. 27, 2010

(51) Int. Cl. B60R 9/00

(52) U.S. Cl. 224/321

(57) ABSTRACT

A rack system for a roof of a vehicle includes a pair of longitudinal bars extending along a longitudinal axis of the vehicle, and a pair of transverse bars attached to the longitudinal bars and extending across the vehicle. A plurality of riser assemblies pivotably interconnects the longitudinal bars to the roof, to raise and lower both the longitudinal bars and the transverse bars between a deployed position and a stowed position. When in the stowed position, the longitudinal bars and the transverse bars are flush with an exterior surface of the roof. When in the deployed position, the longitudinal bars and the transverse bars are spaced from the exterior surface of the roof.

### TECHNICAL FIELD

The invention generally relates to a vehicle, and more specifically to a vehicle having a rack system located on an exterior surface of a roof of the vehicle.

### BACKGROUND

Many vehicles include a rack system that is disposed on an exterior surface of a roof of the vehicle. The rack system may be utilized to secure objects, such as luggage, bicycles, canoes, etc. to the roof of the vehicle. Roof rack systems generally include a pair of longitudinally extending bars that are fixedly attached to the roof, and a pair of transverse bars that attach to and extend between the longitudinal bars.

The longitudinal bars and the transverse bars of the rack system are spaced from the exterior surface of the roof to provide space to tie objects thereto. However, because the longitudinal bars and the transverse bars are spaced from the roof, the longitudinal bars and the transverse bars interfere with and disrupt the flow of air over the roof of the vehicle, thereby increasing drag on the vehicle and reducing the fuel efficiency of the vehicle.

### SUMMARY

A vehicle is provided. The vehicle includes a body that extends along a longitudinal axis. The body defines a roof having an exterior surface. A rack system is disposed on the exterior surface of the roof. The rack system includes at least one longitudinal bar extending along and parallel with the longitudinal axis of the body, and at least one transverse bar extending transverse to the longitudinal axis of the body. Both the longitudinal bar and the transverse bar are moveable between a deployed position and a stowed position. When in the deployed position, both the longitudinal bar and the transverse bar are vertically spaced from the exterior surface of the roof. When in the stowed position, both the longitudinal bar and the transverse bar are substantially flush with the exterior surface of the roof.

A rack system for an exterior surface of a roof of a vehicle is also provided. The rack system includes a first longitudinal bar and a second longitudinal bar spaced from and parallel with the first longitudinal bar. The rack system further includes a first transverse bar and a second transverse bar. The second transverse bar is spaced from and parallel with the first transverse bar. The first transverse bar and the second transverse bar are attached to and extend between the first longitudinal bar and the second longitudinal bar. A plurality of riser assemblies is configured for pivotably interconnecting the roof and each of the first longitudinal bar and the second longitudinal bar to raise and lower the first longitudinal bar, the second longitudinal bar, the first transverse bar and the second transverse bar between a stowed position and a deployed position. When in the deployed position, the first longitudinal bar, the second longitudinal bar, the first transverse bar and the second transverse bar are vertically spaced from the exterior surface of the roof. When in the stowed position, the first longitudinal bar, the second longitudinal bar, the first transverse bar and the second transverse bare are all substantially flush with the exterior surface of the roof.

Accordingly, the rack system may be positioned in the stowed position when not in use. When in the stowed position, the rack system is disposed flush with the exterior surface of the roof, and therefore does not interfere with or disrupt the aerodynamics of the vehicle, thereby improving the fuel efficiency of the vehicle. When needed to secure objects to the roof, the rack system may be moved into the deployed position, thereby allowing the objects to be tied down to the rack system.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a vehicle showing a rack system in a deployed position.

FIG. 2 is a schematic perspective view of the vehicle showing the rack system in a stowed position.

FIG. 3 is a schematic cross section of the vehicle showing a side view of the rack system.

FIG. 4 is an enlarged schematic side view of the vehicle showing a riser assembly of the rack system.

### DETAILED DESCRIPTION

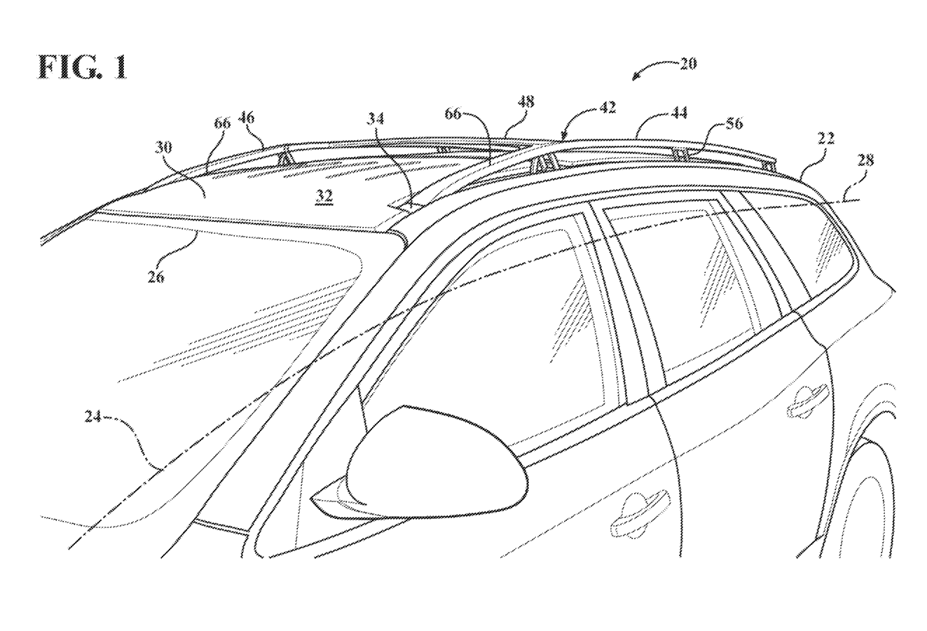

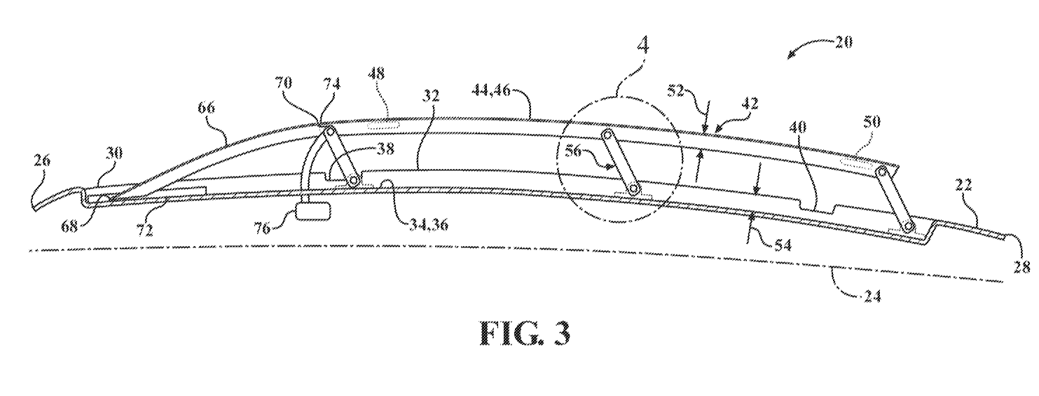

Referring to the Figures, wherein like numerals indicate like parts throughout the several views, a vehicle is shown generally at 20. Referring to FIGS. 1 through 3, the vehicle 20 may include any style and/or size of vehicle 20 including but not limited to a passenger car, a sport utility vehicle or a van.

The vehicle 20 includes a body 22. The body 22 extends along a longitudinal axis 24, and includes a first end 26 and a second end 28 disposed at opposite ends of the vehicle 20 along the longitudinal axis 24. As shown, the first end 26 is a forward end of the vehicle 20, and the second end 28 is a rearward end of the vehicle 20. However, it should be appreciated that the relative positions of the first end 26 and the second end 28 may be reversed.

The body 22 defines a roof 30. The roof 30 may include the uppermost portion of the body 22. However, the roof 30 should be interpreted to include any generally horizontal portion of the vehicle 20. The roof 30 includes an exterior surface 32, and defines a longitudinal channel 34, 36. The longitudinal channel 34, 36 extends along and parallel with the longitudinal axis 24 of the body 22. As shown, the longitudinal channel 34, 36 includes a first longitudinal channel 34 disposed on one longitudinal side of the roof 30 and a second longitudinal channel 36 disposed on an opposite longitudinal side of the roof 30. However, it should be appreciated that the vehicle 20 may define any number of longitudinal channels 34, 36. The roof 30 further defines a transverse channel 38, 40. The transverse channel 38, 40 extends transversely across the roof 30 relative to the longitudinal axis 24 of the body 22. As shown, the transverse channel 38, 40 extends between the first longitudinal channel 34 and the second longitudinal channel 36, and includes a first transverse channel 38 and a second transverse channel 40 spaced from and parallel with the first transverse channel 38. The first transverse channel 38 is disposed nearer the first end 26 of the vehicle 20 than the second transverse channel 40. However, it should be appreciated that the vehicle 20 may define any number of transverse channels 38, 40.

A rack system 42 is disposed on the exterior surface 32 of the roof 30. The rack system 42 includes at least one longitudinal bar 44, 46 and at least one transverse bar 48, 50. The longitudinal bar 44, 46 extends along and parallel with the longitudinal axis 24 of the body 22. As shown, the longitudinal bar 44, 46 includes a first longitudinal bar 44 and a second longitudinal bar 46 disposed on opposite longitudinal sides of the roof 30. The first longitudinal bar 44 is disposed within the first longitudinal channel 34, and the second longitudinal bar 46 is disposed within the second longitudinal channel 36. The transverse bar 48, 50 extends transverse to the longitudinal axis 24 of the body 22, and across the roof 30. The transverse bar 48, 50 is attached to the longitudinal bar 44, 46. More specifically, the transverse bar 48, 50 is attached to both the first longitudinal bar 44 and the second longitudinal bar 46. As shown, the transverse bar 48, 50 includes a first transverse bar 48 and a second transverse bar 50 spaced from the first transverse bar 48. The first transverse bar 48 is disposed within the first transverse channel 38, and the second transverse bar 50 is disposed within the second transverse channel 40.

Throughout the detailed description, reference to the longitudinal bar 44, 46 includes both the first longitudinal bar 44 and the second longitudinal bar 46 unless otherwise specified. Similarly, reference to the transverse bar 48, 50 includes both the first transverse bar 48 and the second transverse bar 50 unless otherwise specified. However, the claims should not be interpreted to require that the longitudinal bar must include both the first longitudinal bar 44 and the second longitudinal bar 46, nor should the claims be interpreted to require that the transverse bar must include both the first transverse bar 48 and the second transverse bar 50.

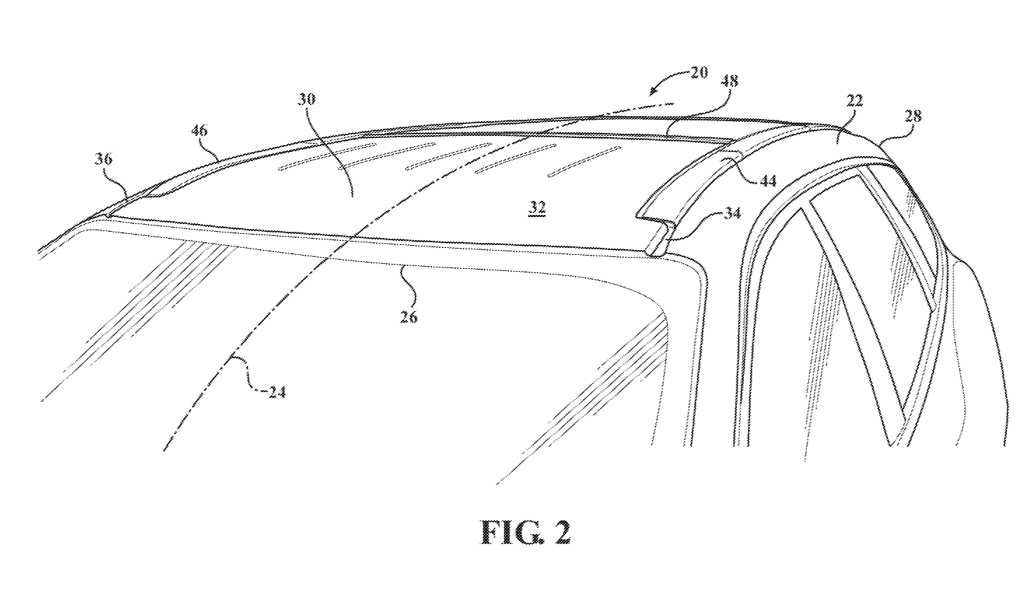

Both the longitudinal bar 44, 46 and the transverse bar 48, 50 are moveable between a deployed position, shown in FIG. 1 and a stowed position, shown in FIG. 2. The longitudinal bar 44, 46 and the transverse bar 48, 50 are coupled together and move simultaneously with each other between the stowed position and the deployed position. When in the deployed position, both the longitudinal bar 44, 46 and the transverse bar 48, 50 are vertically spaced from the exterior surface 32 of the roof 30. When in the stowed position, both the longitudinal bar 44, 46 and the transverse bar 48, 50 are substantially flush with the exterior surface 32 of the roof 30 when in the stowed position. Accordingly, the longitudinal bar 44, 46 is disposed within and recessed into the longitudinal channel 34, 36, and the transverse bar 48, 50 is disposed within and recessed into the transverse channel 38, 40 when in the stowed position.

The longitudinal bar 44, 46 and the transverse bar 48, 50 each include a thickness 52. The longitudinal channel 34, 36 and the transverse channel 38, 40 each extend a vertical depth 54 below the exterior surface 32 of the roof 30. The thickness 52 of the longitudinal bar 44, 46 and the transverse bar 48, 50 is substantially equal to the vertical depth 54 of the longitudinal channel 34, 36 and the transverse channel 38, 40 so that when in the stowed position, the longitudinal bar 44, 46 and the transverse bar 48, 50 may be positioned substantially flush with the exterior surface 32 of the roof 30 such that the longitudinal bar 44, 46 and the transverse bar 48, 50 do not appreciably extend upward beyond the exterior surface 32 of the roof 30.

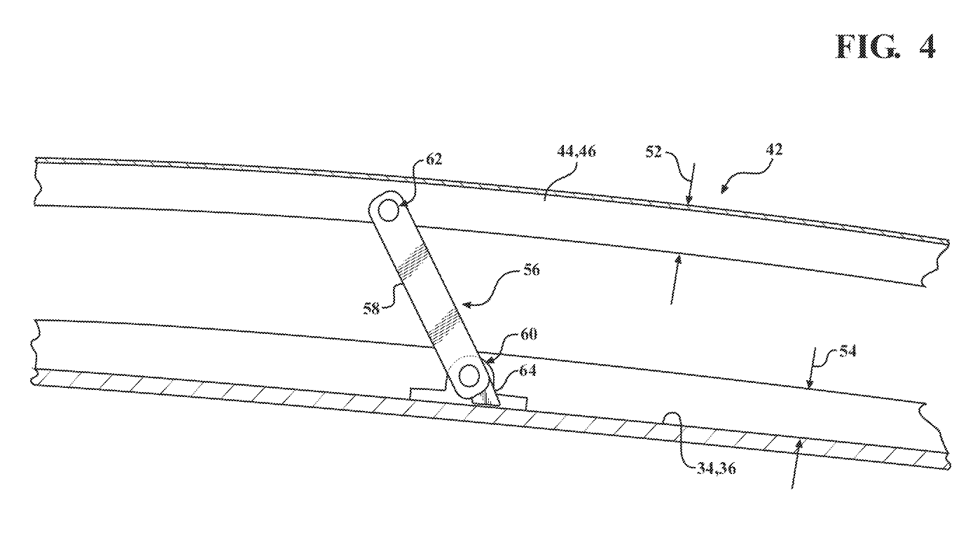

Referring also to FIG. 4, the rack system 42 includes at least one riser assembly 56. As shown, the rack system 42 includes a plurality of riser assemblies 56. Each riser assembly 56 pivotably interconnects the roof 30 and the longitudinal bar 44, 46. The riser assembly 56 pivots relative to the roof 30 and the longitudinal bar 44, 46 to raise and lower the longitudinal bar 44, 46 and the transverse bar 48, 50 between the stowed position and the deployed position. As best shown in FIG. 4, the riser assembly 56 includes a strut 58, a first pivot connection 60 and a second pivot connection 62. The first pivot connection 60 interconnects the roof 30 and the strut 58. The second pivot connection 62 interconnects the strut 58 and the longitudinal bar 44, 46. When positioned in the deployed position, movement of the longitudinal bar 44, 46 toward the first end 26 of the vehicle 20 causes the strut 58 to pivot toward the first end 26 of the vehicle 20 and lay down flat against the roof 30, within the longitudinal channel 34, 36. When positioned in the stowed position, movement of the longitudinal bar 44, 46 toward the second end 28 of the vehicle 20 causes the strut 58 to pivot toward the second end 28 of the vehicle 20 and raise up until standing substantially vertical relative to the roof 30, thereby raising the longitudinal bars 44, 46 vertically relative to the roof 30. As the transverse bar 48, 50 is attached to the longitudinal bar 44, 46, the transverse bar 48, 50 moves with the longitudinal bar 44, 46 between the deployed position and the stowed position.

As shown, each of the riser assemblies 56 pivot in a direction toward the second end 28 of the vehicle 20, i.e., toward a rear of the vehicle 20, when moving from the stowed position into the deployed position. The rack system 42 may further include a stop 64. The stop 64 is configured for preventing pivotal movement of the at least one riser assembly 56 in a direction toward the second end 28 of the vehicle 20, i.e., in a rearward direction, beyond the deployed position. When so arranged, the wind resistance against objects secured to the rack system 42 will generally push the rack system 42 into the deployed position, so that the rack system 42 is not inadvertently pushed into the stowed position when in use.

The rack system 42 may further include a guide member 66. The guide member 66 includes a first end 68 and a second end 70. The first end 68 of the guide member 66 is slideable relative to the roof 30, and is disposed in the longitudinal channel 34, 36. A rail 72 is attached to the roof 30, and is disposed within the longitudinal channel 34, 36. The first end 68 of the guide member 66 is slideably coupled to the rail 72. The first end 68 of the guide member 66 slides longitudinally along the rail 72. The second end 70 of the guide member 66 is pivotably coupled to a first end 74 of the longitudinal bar 44, 46.

The vehicle 20 and/or the rack system 42 may include an actuator 76. The actuator 76 may be coupled to the rack system 42 and configured for moving the rack system 42 between the deployed position and the stowed position. For example, the actuator 76 may include, but is not limited to an electric motor and all gearing and linkages necessary to connect the electric motor to the rack system 42. Alternatively, it should be appreciated that the rack system 42 may not include the actuator 76, and may be manually moved between the deployed position and the stowed position.

While the best modes for carrying out the invention have been described in detail, those familiar with the art to which this invention relates will recognize various alternative designs and embodiments for practicing the invention within the scope of the appended claims.

1. A vehicle comprising:
a body extending along a longitudinal axis and defining a roof having an exterior surface; and
a rack system disposed on the exterior surface of the roof and including at least one longitudinal bar extending along and parallel with the longitudinal axis of the body and at least on transverse bar extending transverse to the longitudinal axis of the body;
wherein both the longitudinal bar and the transverse bar are moveable between a deployed position and a stowed position, with both the longitudinal bar and the transverse bar vertically spaced from the exterior surface of the roof when in the deployed position and substantially flush with the exterior surface of the roof when in the stowed position.

2. A vehicle as set forth in claim 1 wherein the roof defines a longitudinal channel extending along and parallel with the longitudinal axis of the body, with the longitudinal bar disposed within the longitudinal channel when in the stowed position.

3. A vehicle as set forth in claim 2 wherein the longitudinal bar includes a thickness and the longitudinal channel extends a vertical depth below the exterior surface of the roof, wherein the thickness of the longitudinal bar is substantially equal to the vertical depth of the longitudinal channel.

4. A vehicle as set forth in claim 2 wherein the roof defines a transverse channel extending transversely across the roof relative to the longitudinal axis of the body, with the transverse bar disposed within the transverse channel when in the stowed position.

5. A vehicle as set forth in claim 4 wherein the transverse bar includes a thickness and the transverse channel extends a vertical depth below the exterior surface of the roof, wherein the thickness of the transverse bar is substantially equal to the vertical depth of the transverse channel.

6. A vehicle as set forth in claim 1 wherein the longitudinal bar and the transverse bar are coupled together and move simultaneously with each other between the stowed position and the deployed position.

7. A vehicle as set forth in claim 1 wherein the rack system includes at least one riser assembly pivotably interconnecting the roof and the longitudinal bar.

8. A vehicle as set forth in claim 7 wherein the at least one riser assembly pivots relative to the roof and the longitudinal bar to raise and lower the longitudinal bar and the transverse bar between the stowed position and the deployed position.

9. A vehicle as set forth in claim 8 wherein the at least one riser assembly includes a strut, a first pivot connection interconnecting the roof and the strut, and a second pivot connection interconnecting the strut and the longitudinal bar.

10. A vehicle as set forth in claim 9 wherein the at least one riser assembly pivots in a direction toward a rear of the vehicle when moving from the stowed position into the deployed position.

11. A vehicle as set forth in claim 10 wherein the rack system includes a stop configured for preventing pivotal movement of the at least one riser assembly in a rearward direction beyond the deployed position.

12. A vehicle as set forth in claim 1 wherein the rack system includes a guide member having a first end slideable relative to the roof and disposed in the longitudinal channel and a second end pivotably coupled to a first end of the longitudinal bar.

13. A vehicle as set forth in claim 12 wherein the rack system includes a rail attached to the roof and disposed within the longitudinal channel, with the first end of the guide member slideably coupled to the rail.

14. A vehicle as set forth in claim 1 further comprising an actuator coupled to the rack system and configured for moving the rack system between the deployed position and the stowed position.

15. A vehicle as set forth in claim 14 wherein the actuator includes an electric motor.

16. A vehicle as set forth in claim 1 wherein the longitudinal bar includes a first longitudinal bar and a second longitudinal bar disposed on opposite longitudinal sides of the roof.

17. A vehicle as set forth in claim 16 wherein the transverse bar includes a first transverse bar and a second transverse bar spaced from the first transverse bar.

18. A rack system for a roof of a vehicle, wherein the roof includes an exterior surface, the rack system comprising;
a first longitudinal bar and a second longitudinal bar spaced from and parallel with the first longitudinal bar;
a first transverse bar and a second transverse bar spaced from and parallel with the first transverse bar, wherein the first transverse bar and the second transverse bar are attached to and extend between the first longitudinal bar and the second longitudinal bar;
a plurality of riser assemblies configured for pivotably interconnecting the roof and each of the first longitudinal bar and the second longitudinal bar to raise and lower the first longitudinal bar, the second longitudinal bar, the first transverse bar and the second transverse bar between a stowed position and a deployed position, with the first longitudinal bar, the second longitudinal bar, the first transverse bar and the second transverse bar vertically spaced from the exterior surface of the roof when in the deployed position, and substantially flush with the exterior surface of the roof when in the stowed position.

19. A rack system as set forth in claim 18 wherein each of the plurality of riser assemblies includes a strut, a second pivot connection interconnecting the strut and the longitudinal bar, and a first pivot connection configured for interconnecting the roof and the strut.

20. A rack system as set forth in claim 19 further comprising an actuator coupled to at least one of the first longitudinal bar and the second longitudinal bar and configured for moving the rack system between the deployed position and the stowed position.
